(19) United States
(12) Patent Application Publication
(10) Pub. No.: US 2007/0293166 A1
(43) Pub. Date: Dec. 20, 2007

(54) Protective device and system for a mobile computing device

(76) Inventors: Amir Weiss, Patchogue, NY (US); Robert Spano, Smithtown, NY (US)

Correspondence Address: FAY KAPLUN & MARCIN, LLP, 15O BROADWAY, SUITE 702, NEW YORK, NY, 10038, US

(21) Appl. No.: 11/446,984

(22) Filed: Jun. 5, 2006

(51) Int. Cl. H04B 1/034

(52) U.S. Cl. 455/128

(57) ABSTRACT

Described is a protective device and system for a mobile computing device. The system comprises a rigid cage and a protective boot. The rigid cage is shaped to protect an attachment point of a mobile device receiving a removable connector. The rigid cage is shaped to receive the attachment point and the removable connector. The protective boot is shaped to receive the rigid cage and a portion of the mobile device. The portion of the mobile device includes the attachment point.

### FIELD OF INVENTION

The present invention relates generally to protective devices and systems for mobile computing devices.

### BACKGROUND

The use of mobile computing devices is prevalent in modern society. Such devices are commonly used for both personal and business tasks. Depending on its size, a mobile device may be carried in the user's hand, stored in a pocket, or attached to the user in another manner, such as by a wrist strap or belt clip.

Many mobile devices contain sophisticated and fragile electronic components. In addition, mobile devices may also include jacks and/or connectors for peripheral devices such as head phones and earpieces. These connectors between the mobile device and the peripheral devices are also fragile. Such components or connectors can be damaged if a mobile device is dropped, and repair can be both expensive and time-consuming.

### SUMMARY OF THE INVENTION

The present invention relates to a protective device and system for a mobile computing device. The system comprises a rigid cage and a protective boot. The rigid cage is shaped to protect an attachment point of a mobile device receiving a removable connector. The rigid cage is shaped to receive the attachment point and the removable connector. The protective boot is shaped to receive the rigid cage and a portion of the mobile device. The portion of the mobile device includes the attachment point.

### BRIEF DESCRIPTION OF THE DRAWINGS

FIG. 1 shows an exemplary embodiment of a mobile device according to the present invention.

FIG. 2 shows an exemplary embodiment of a protective boot according to the present invention.

FIG. 3 shows an exemplary embodiment of a rigid cage according to the present invention.

FIG. 4 shows an exemplary embodiment of a binding element according to the present invention.

FIG. 5 shows an exemplary embodiment of a cable and overmolded strain relief according to the present invention.

FIG. 6 shows a rear view of an exemplary embodiment of the mobile device and attached cable, overmolded strain relief and binding element according to the present invention.

FIG. 7 shows a second view of an exemplary embodiment of the mobile device and attached cable, overmolded strain relief and binding element according to the present invention.

FIG. 8 shows an exemplary embodiment of the mobile device and attached cable, overmolded strain relief, binding element, rigid cage and protective boot according to the present invention.

### DETAILED DESCRIPTION

The present invention may be further understood with reference to the following description and the appended drawings, wherein like elements are provided with the same reference numerals. The present invention relates to a boot that provides improved protection for a mobile computing device, including protection of attached peripheral devices and the user of the mobile devices.

The present invention is described with reference to an exemplary mobile computing device. It will be apparent to those skilled in the art that the present invention may be applied to any mobile computing device. In addition, the terms mobile computing device and/or mobile device will be used throughout this description to refer to any type of device that is mobile and includes a processor. Examples of mobile devices include, mobile phones, handheld computers, personal digital assistants (“PDAs”), MP3 player, bar code reader, optical reader, digital camera, two way pager, etc.

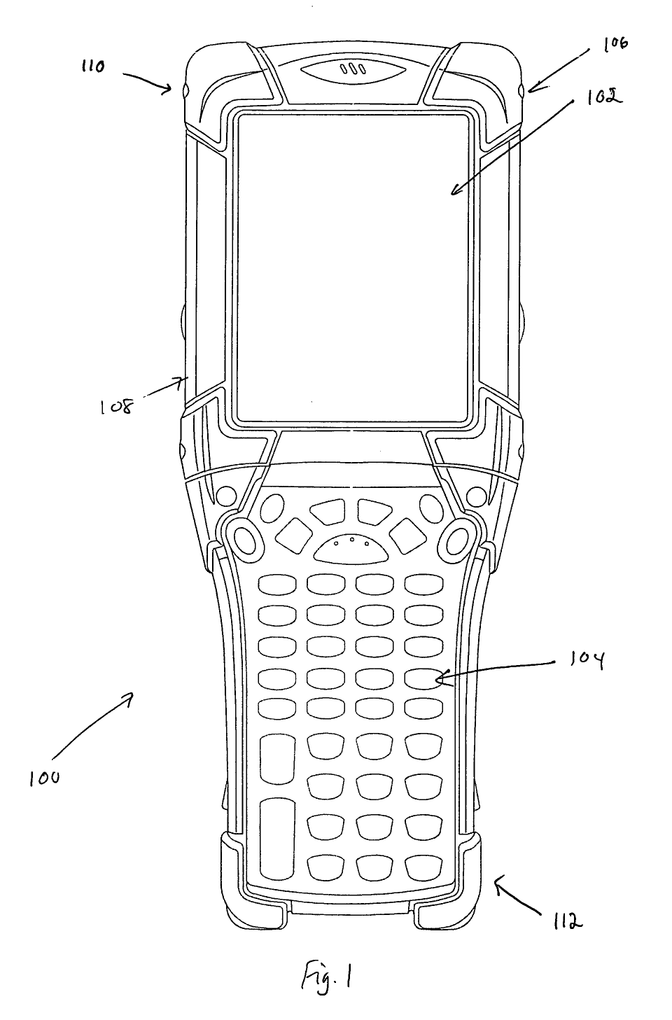

FIG. 1 shows an exemplary embodiment of a mobile device 100 having a first end 110 and a second end 112. The mobile device also includes a display 102, a keypad 104, a jack 106 and an outer housing 108. The display 102 may be any screen that provides visual output to the user. The user may accomplish manual input through the keypad 104. The jack 106 may be sized and shaped to receive a plug, such as, but not limited to, an audio plug.

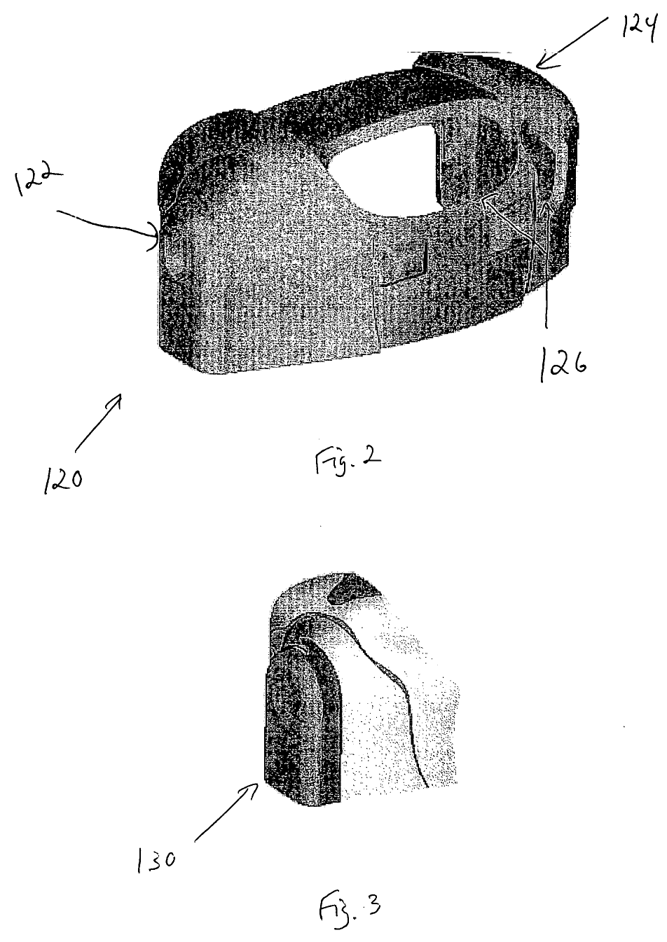

FIG. 2 shows an exemplary embodiment of a protective boot 120. The protective boot may be, for example, molded using a low durometer rubber to be resiliently flexible. The boot 120 is sized and shaped to fit tightly over the first end 110 of the mobile device 100 and not dislodge inadvertently, but so that the mobile device 100 can also be removed and reinserted if the user desires. Those skilled in the art will understand that the protective boot 120 may be manufactured in different manners or made of different materials to accomplish the described function of the protective boot. In addition, the protective boot 120 is not limited to receiving the first end 110 of the mobile device 100, but may be sized and shaped to receive any portion of the mobile device 100, such as the second end 112 or any other portion thereof. That is, the protective boot 120 may be made of any material that allows the protective boot to be placed over a portion of the mobile device 100 and protects the mobile device 100.

Because the exemplary protective boot 120 will be placed over a portion of the mobile device 100 that includes the jack 106, the protective boot 120 may include a first portion 122 which is sized and shaped to partially surround the jack 106 of the mobile device 100. The boot 120 may also include a second portion 124 and vias 126 through which components of the first end 110 of the mobile device 100 may be accessed if desired. For example, the mobile device 100 may include a bar code reader or laser scanner having an access window in the first end 110. The larger via 126 of the protective boot 120 may be sized so that the window of the scanner is protected, but not covered by the protective boot 120. Thus, the scanner or reader may be continued to be used properly even with the protective boot 120 in place. Again, those skilled in the art will understand that the protective boot 120 may be sized and shaped to accommodate any features of the mobile device 100.

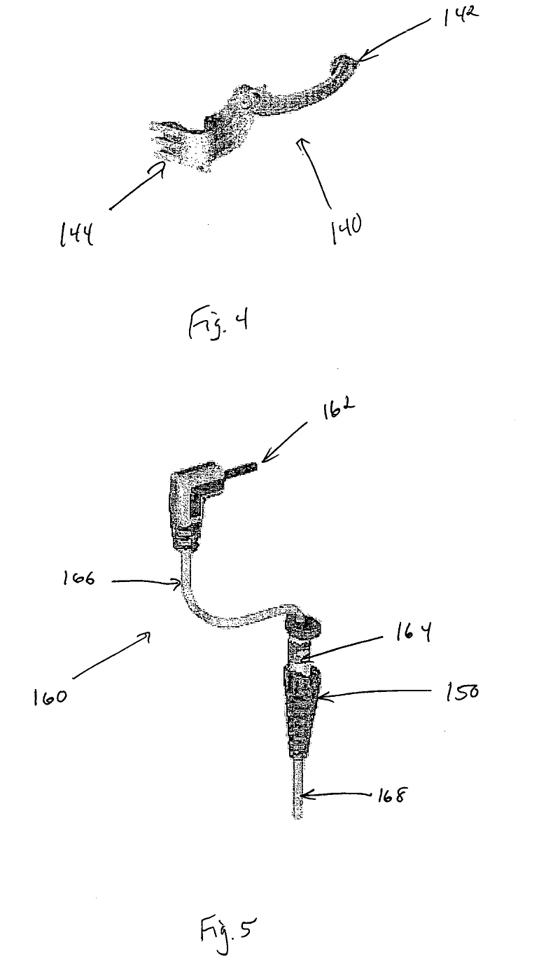

FIG. 3 shows an exemplary embodiment of a rigid cage 130. In the exemplary embodiment, the rigid cage 130 is insert molded into the protective boot 120. However, those skilled in the art will understand that the rigid cage 130 may be a separate component that is not joined to the protective boot 120. The rigid cage 130 may be made of a material that is more rigid than the protective boot, for example, a rigid plastic. In the exemplary embodiment, the rigid cage 130 is designed to provide extra protection to the jack 106 portion of the mobile device 100. The jack 106 portion may be more fragile than other elements of the first end 112 because the jack 106 will receive a plug of a peripheral device (e.g., an earpiece). Thus, the profile of the mobile device 100 with a plug connected to the jack 106 is an especially fragile area. Therefore, additional protection in this fragile area may be appropriate. Thus, when the rigid cage 130 is molded into the protective boot 120 and the combination is placed over the first end 112, the rigidity of the cage 130 in combination with the protective boot 120 offers increased protection in the area of the jack 106.

Those skilled in the art will understand that the rigid cage 130 may also be sized and shaped to add additional protection to any component of the mobile device 100. For example, the mobile device may include a series of jacks and each jack may have a separate rigid cage 130 or a single rigid cage 130 may protect multiple jacks. Thus, a single protective boot 120 may be reinforced with one or more rigid cages 130. In addition, while the element 130 is termed a rigid cage, it does not need to be in the form of a cage, i.e., a structure having openings. For example, the rigid cage 130 may be in the form of a solid object without any openings.

FIG. 4 shows an exemplary embodiment of a binding element 140 according to the present invention. In the exemplary embodiment, a first end 142 of the binding element 140 is affixed to the outer housing 108 of the mobile device 100. The first end 142 may be affixed to the mobile device 100 by any standard means for affixing components used in the art (e.g., screws, adhesive, locking mechanism, hook and eye fastener, etc.). The binding element 140 may also include a second end 144. In the exemplary embodiment, the binding element 140 is shaped such that when the first end 142 is affixed to the outer housing 108, the second end 144 and the outer housing 108 form a substantially closed loop. The function of the binding element 140 will be described in greater detail below.

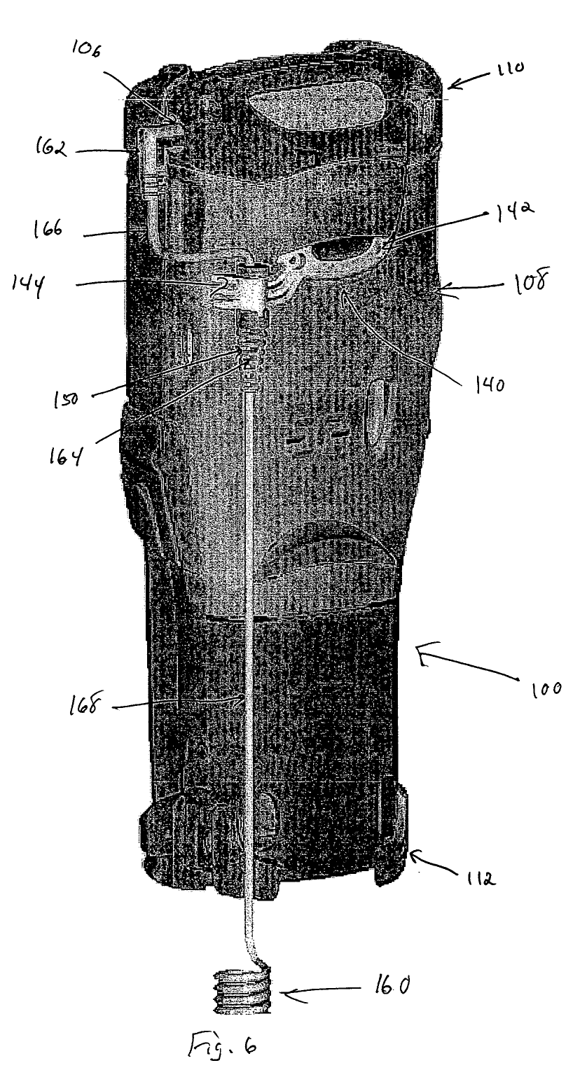

FIG. 5 shows an exemplary embodiment of a overmolded strain relief 150 and cable 160 of the present invention. The cable 160 may include a plug 162 sized to be received by the jack 106 of the mobile device 100. The interior of the overmolded strain relief 150 is sized to tightly enclose a first portion 164 of the cable 160 in a manner such that the first portion 164 is stationary with respect to the overmolded strain relief 150. The exterior of the overmolded strain relief 150 is sized and shaped to mate with the second end 144 of the binding element 140. The cable 160 may also include a second portion 166 located between the first portion 164 and the plug 162, as well as a third portion 168 located on the opposite side of the first portion 164 from the second portion 166.

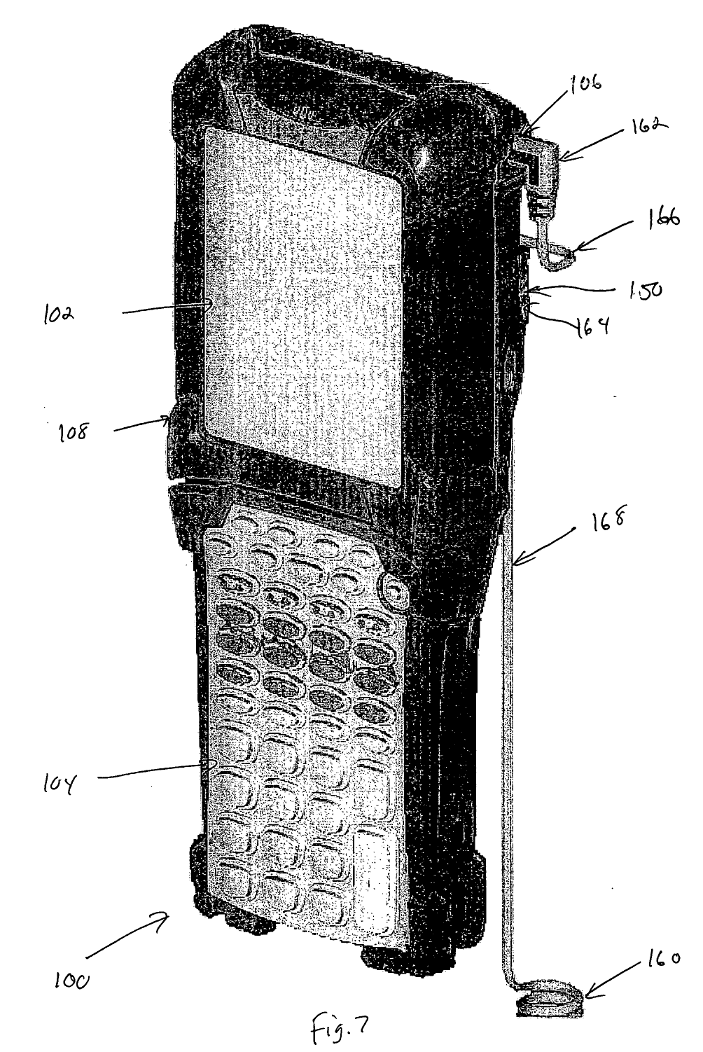

FIG. 6 shows an exemplary embodiment of the mobile device 100, the binding element 140, the overmolded strain relief 150 and the cable 160. The plug 162 may be inserted into the jack 106 as shown. In the exemplary embodiment, when the binding element 140 is affixed to the mobile device 100, the second end 144 of the binding element 140 and the outer housing 108 of the mobile device 100 enclose and constrain the movement of the overmolded strain relief 150. As a result, the movement of the first portion 164 of the cable 160 is also constrained.

This restriction of movement provides substantial protection to the mobile device 100, most particularly to the jack 106. Tension exerted along the third portion 168 of the cable 160 (as can result, for example, if the mobile device 100 is dropped) is absorbed through the first portion 164 of the cable, the second end 144 of the binding element 140, the first end 142 of the binding element 140, and into the outer housing 108 of the mobile device 100. This prevents the tension from instead being absorbed through the second portion 166 of the cable 160, the plug 162 of the cable 160, and into the jack 106 of the mobile device 100. In this way, the combination of the binding element 140 and the overmolded strain relief 150 prevents damage to the jack 106 that might otherwise result from the mobile device 100 being dropped or otherwise damaged from pulling on the cable 160.

FIG. 7 shows the same exemplary embodiment of FIG. 6 when viewed from the opposite direction. While the combination of the binding element 140 and the overmolded strain relief 150 are sufficient to prevent damage to the plug 162 and jack 106 because of pulling or tugging on the cable 160, the plug 162 of the cable 160 and the jack 106 of the mobile device 100 are exposed and remain susceptible to impact damage if the mobile device 100 is dropped.

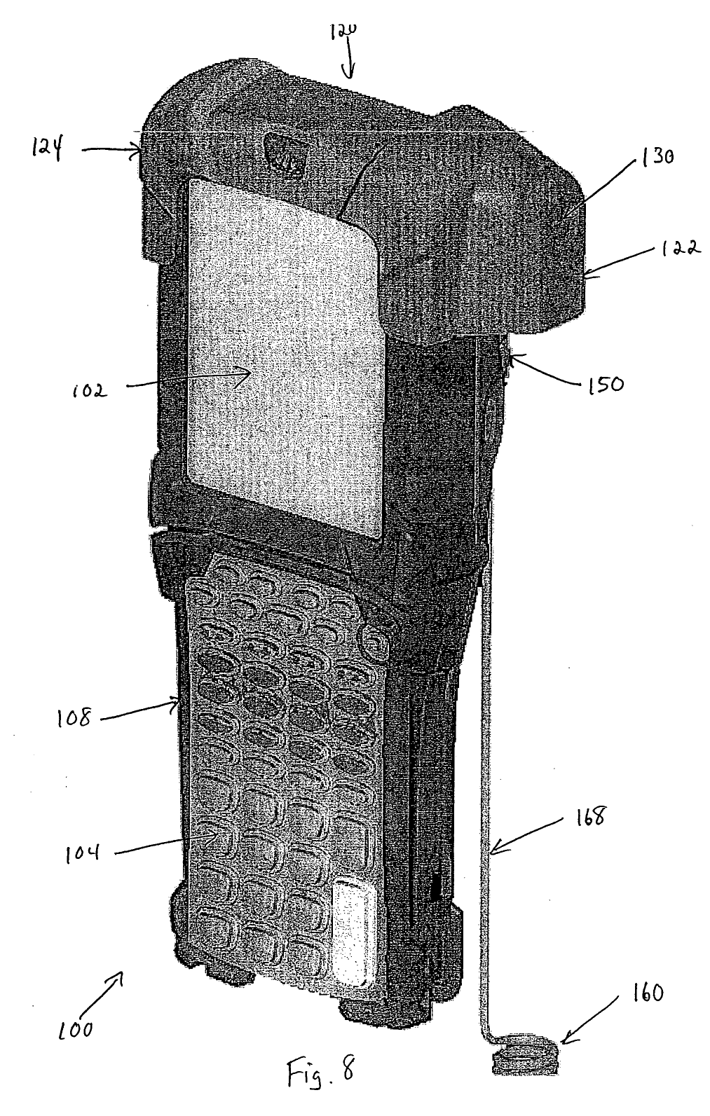

FIG. 8 shows an exemplary embodiment of the mobile device 100 including all the protective elements described above, e.g., the protective boot 120, the rigid cage 130, the binding element 140 (not seen directly in this figure), the overmolded strain relief 150 and the cable 160, all in the attached position. As described above, in this exemplary embodiment, the binding element 140 and overmolded strain relief 150 prevent damage to the jack 106 of the mobile device 100 caused by tension along the cable 160. The exemplary embodiment shown in FIG. 8 provides additional protection by the addition of the rigid cage 130 and the protective boot 120. In this embodiment, the first portion 122 of the boot 120 and the rigid cage 130 are sized and shaped so that they surround the combination of the plug 162 and the jack 106. The first portion 122 of the protective boot is shaped such that it does not impede the path of the cable 160 from the jack 106 to the binding element 140. As described above, the rigid cage 130 provides added stiffness to the first portion 122 of the boot 120. In this manner, the combination of the rigid cage 130 and the protective boot 120 provide impact protection to the plug 162 and the jack 106 if the mobile device 100 is dropped.

As described above, the protective elements (protective boot, rigid cage, binding element, overmolded strain relief) have been described with reference to the specific embodiment of the mobile device 100 and its described size, shape and features. However, those skilled in the art will understand that the protective elements may be modified to fit and protect any type of mobile device without departing from the scope and spirit of the present invention.

The present invention has been described with reference to the above exemplary embodiment. One skilled in the art would understand that the present invention may also be successfully implemented if modified. Accordingly, various modifications and changes may be made to the embodiment without departing from the broadest spirit and scope of the present invention as set forth in the claims that follow. The specification and drawings, accordingly, should be regarded in an illustrative, rather than restrictive, sense.

What is claimed is:

1. A system, comprising:
a rigid cage shaped to protect an attachment point of a mobile device receiving a removable connector, the rigid cage being shaped to receive the attachment point and the removable connector; and
a protective boot shaped to receive the rigid cage and a portion of the mobile device, the portion of the mobile device including the attachment point.

2. The system of claim 1, wherein the rigid cage is insert molded into the protective boot.

3. The system of claim 1, wherein the protective boot has a first rigidity and the rigid cage has a second rigidity.

4. The system of claim 3, wherein the first rigidity is less than the second rigidity.

5. The system of claim 1, wherein the attachment point is a jack.

6. The system of claim 1, wherein the removable connector is a plug.

7. The system of claim 1, wherein the protective boot is shaped to be stretch fit on the portion of the mobile device.

8. The system of claim 1, wherein the rigid cage and the protective boot removably receive the mobile device.

9. The system of claim 1, further comprising:
a cable including the removable connector connecting to the attachment point of the mobile device;
a overmolded strain relief receiving the cable; and
a binding element coupled to a housing of the mobile device and receiving the overmolded strain relief, thereby immobilizing the cable from the overmolded strain relief to the removable connector relative to the housing.

10. The system of claim 1, wherein the protective boot is formed of a flexible material.

11. The system of claim 10, wherein the flexible material is a low durometer rubber.

12. The system of claim 1, wherein the rigid cage is formed of plastic.

13. A system, comprising:
a cable including a removable connector connecting to an attachment point of a mobile device;
a overmolded strain relief receiving the cable; and
a binding element coupled to a housing of the mobile device and receiving the overmolded strain relief, thereby immobilizing the cable from the overmolded strain relief to the removable connector relative to the housing.

14. The system of claim 13, wherein tension exerted on a non-mobilized portion of the cable is not transmitted to the immobilized portion of the cable.

15. The system of claim 13, wherein the overmolded strain relief is permanently affixed to the cable.

16. The system of claim 13, wherein the overmolded strain relief is received in an opening formed between the binding element and the housing, wherein a diameter of the opening is less than an outer diameter of the overmolded strain relief.

17. The system of claim 13, further comprising:
a rigid cage shaped to protect the attachment point of the mobile device, the rigid cage being shaped to receive the attachment point and the removable connector; and
a protective boot shaped to receive the rigid cage and a portion of the mobile device, the portion of the mobile device including the attachment point.

18. A system, comprising:
a first protecting means for protecting an attachment point of a mobile device receiving a removable connector, the means being shaped to receive the attachment point and the removable connector; and
a second protecting means for receiving the first protective means and a portion of the mobile device, the portion of the mobile device including the attachment point.

19. A system, comprising:
a cable including connecting means for connecting to an attachment means of a mobile device; and
a binding means for immobilizing a portion of the cable relative to a housing of the mobile device.

20. The system of claim 19, further comprising:
a overmolded strain relief means for holding the cable, wherein the binding means receives the overmolded strain relief means to immobilize the portion of the cable.
